(19) United States
(12) Patent Application Publication
(10) Pub. No.: US 2026/0024512 A1
(43) Pub. Date: Jan. 22, 2026

(54) DRUM SUPPORT DEVICE AND DRUM DEVICE

(71) Applicant: YAMAHA CORPORATION, Hamamatsu-shi (JP)

(72) Inventor: Yukimasa OKUMURA, Hamamatsu-shi (JP)

(21) Appl. No.: 19/240,725

(22) Filed: Jun. 17, 2025

(30) Foreign Application Priority Data
Jul. 17, 2024 (JP) 2024-114085

(51) Int. Cl. G10D 13/10

(52) U.S. Cl. CPC G10D 13/28

(57) ABSTRACT

A drum support device is for supporting a body part of a drum with respect to a drum stand. The drum support device includes a spring having, in an axial direction of the spring, a first end and a second end. The body part of the drum is connected to the first end of the spring, and the drum stand is connected to the second end of the spring.

### CROSS-REFERENCE TO RELATED APPLICATIONS

The present application claims priority to Japanese Patent Application No. 2024-114085, filed Jul. 17, 2024, the content of which is incorporated herein by reference.

### BACKGROUND OF THE INVENTION

### Field of the Invention

The present disclosure relates to a drum support device and a drum device.

### Description of the Related Art

Japanese Unexamined Patent Application, First Publication No. 2016-173417 (hereinafter Patent Document 1) discloses a drum support device (bearing part) for rotatably supporting a concert drum, which is a type of drum, on a stand. The drum support device disclosed in Patent Document 1 includes a rotation shaft (shaft part) attached to the stand and a cushioning material that connects the rotation shaft to the body part of the drum (drum shell). Patent Document 1 discloses that the cushioning material is a tubular body made of an elastically stretchable rubber and is positioned between the rotation shaft and the outer surface of the body part.

### SUMMARY OF THE INVENTION

However, in the case where the cushioning material in Patent Document 1 is made of a rubber, the vibrations generated when the drum is struck are absorbed by the cushioning material, reducing their transmission to the floor through the stand. In the performance of a drum, such as a concert drum, placed on the floor, both the sound resonance generated from the drum itself in response to the strike on the drum and the sound resonance from the floor, caused by the transmission of vibrations from the drum to the floor through the stand, are important. Therefore, if the vibrations of the drum are absorbed by the cushioning material, a problem arises in that the sound resonance during drum performance is insufficient.

Moreover, in the drum support device of Patent Document 1, the cushioning material is simply positioned between the rotation shaft and the outer surface of the body part. As a result, the cushioning material may stretch and contract in the radial direction of the drum (drum shell) in response to the vibrations generated by the drum strike. In such a case, the vibrations of the drum generated by the strike are absorbed by the cushioning material, reducing their transmission to the floor through the stand. Therefore, a problem arises in that the sound resonance during drum performance is insufficient.

The present disclosure takes into consideration the above circumstances, with an object of providing a drum support device and a drum device including the same, capable of improving the sound resonance during drum performance.

A first aspect of the present disclosure is a drum support device for supporting a body part of a drum with respect to a drum stand, including: a spring having, in an axial direction of the spring, a first end and a second end. The body part of the drum is connected to the first end of the spring, and the drum stand is connected to the second end of the spring.

A second aspect of the present disclosure is a drum device including: the above-mentioned drum support device; the drum; and the drum stand that supports the body part of the drum. The drum support device includes two drum support devices provided on both sides of the drum in a radial direction of the drum, respectively.

A third aspect of the present disclosure is a drum support device for supporting a body part of a drum with respect to a drum stand, including: an elastic body having, in an axial direction of the elastic body, a first end and a second end. The body part of the drum is connected to the first end of the elastic body, and the drum stand is connected to the second end of the elastic body. The elastic body is configured to elastically deform only in an orthogonal direction. The orthogonal direction is a direction orthogonal to a radial direction of the drum.

A fourth aspect of the present disclosure is a drum device including: the above-mentioned drum support device; the drum; and the drum stand that supports the body part of the drum. The drum support device includes two drum support devices provided on both sides of the drum in the radial direction of the drum, respectively.

### BRIEF DESCRIPTION OF THE DRAWINGS

FIG. 1 is a diagram showing the exterior of a drum device according to an embodiment of the present disclosure.

FIG. 2 is a schematic diagram of a main part of the drum device of FIG. 1 as viewed from an axial direction of the drum.

FIG. 3 is a schematic diagram of a main part of the drum device of FIG. 1 as viewed from an axial direction of a rotation shaft.

FIG. 4 is a side view of a drum support device of an embodiment of the present disclosure, viewed from the axial direction of the rotation shaft.

FIG. 5 is a cross-sectional view along the section line V-V in FIG. 4.

FIG. 6 is a side view showing a spring included in the drum support device of FIG. 3 and FIG. 4.

FIG. 7 is a top view of the spring of FIG. 6 as viewed from a direction indicated by reference symbol VII.

### DESCRIPTION OF THE EMBODIMENTS

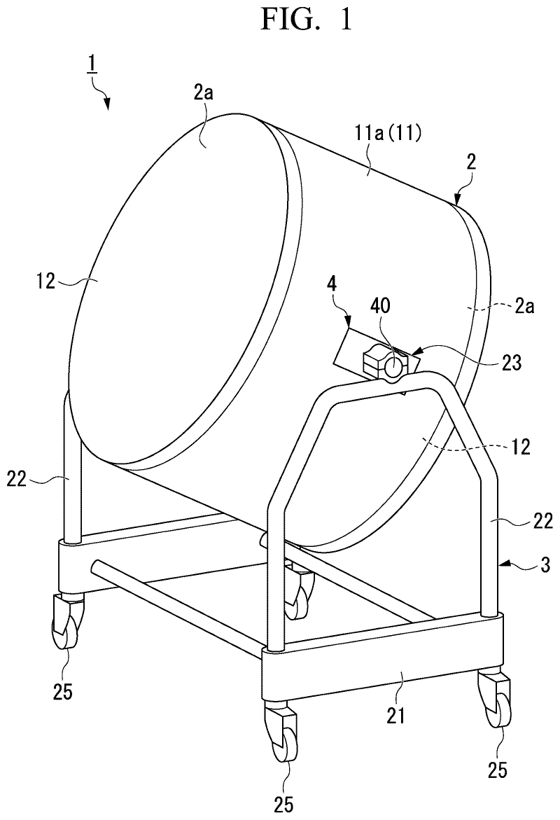

Hereinafter, embodiments of the present disclosure will be described, with reference to FIG. 1 through FIG. 7.

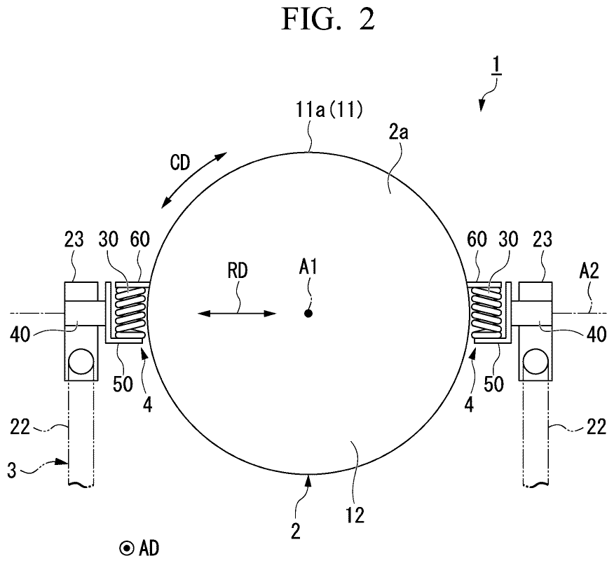

As shown in FIG. 1 and FIG. 2, a drum device 1 of the present embodiment includes a drum 2, a stand 3 that supports the drum 2, and drum support devices 4 for supporting a body part 11 of the drum 2 on the stand 3.

As shown in FIG. 1 through FIG. 3, the drum 2 in the present embodiment is a so-called concert bass drum. The drum 2 has a body part 11 and a head 12. The body part 11 has an opening into which the head 12 is attached. Specifically, the body part 11 is formed in a cylindrical shape having openings at both ends. The diameter of the body part 11 remains constant in the axial direction of the body part 11. The head 12, covering the opening of the body part 11, forms a striking surface 2a of the drum 2, which is struck by a stick or similar implement.

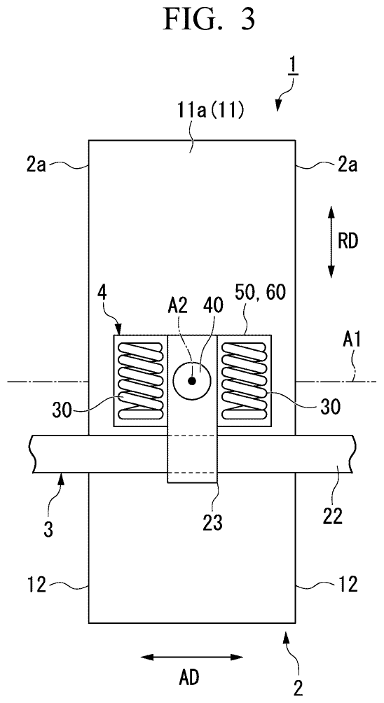

In the present embodiment, the radial direction of the opening of the body part 11 is defined as a radial direction RD of the drum 2 (see FIG. 2 and FIG. 3). Moreover, the direction in which an axis Al of the body part 11 extends, passing through the center of the opening and orthogonal to both the radial direction RD of the body part 11 and the striking surface 2a of the head 12, is defined as an axial direction AD of the drum 2 (see FIG. 2 and FIG. 3). Also, the direction around the axis Al of the body part 11 is defined as a circumferential direction CD of the drum 2 (see FIG. 2). In the present specification, the circumferential direction CD of the drum 2 corresponds to a direction orthogonal to both the radial direction RD and the axial direction AD of the drum 2.

As shown in FIG. 1 and FIG. 2, the stand 3 has a leg part 21 that is placed on the floor, and two supporting parts 22 that extend upward from the leg part 21 and are spaced apart from each other. The drum 2 is arranged between the two supporting parts 22 and attached to the two supporting parts 22 via the drum support devices 4. Each supporting part 22 has a connecting part 23 located at an upper end part thereof for connecting the drum support device 4, which will be described later, to the supporting part 22. The connecting parts 23 are located on both sides of the drum 2 in the radial direction RD of the drum 2.

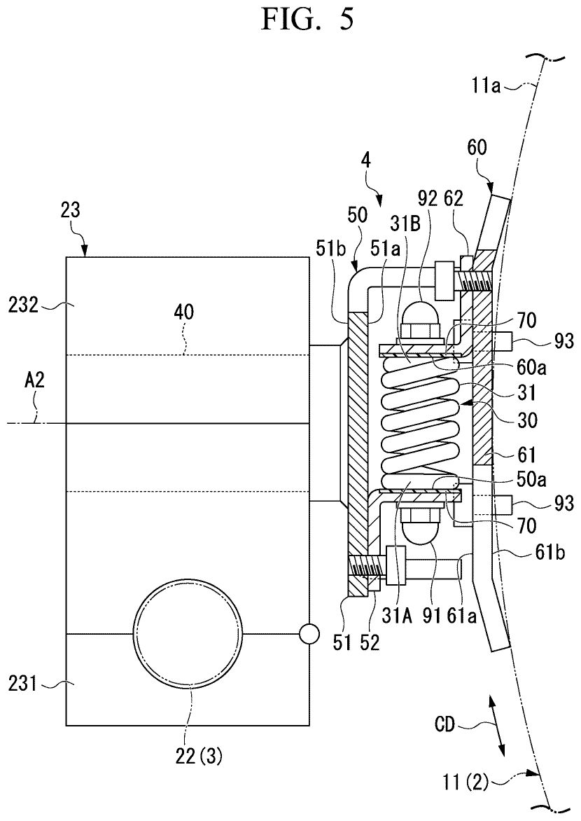

The specific configuration of the leg part 21 and each supporting part 22 may be arbitrary. In the present embodiment, the leg part 21 has multiple casters 25 and this allows the drum device 1 to be easily moved on the floor. Each supporting part 22 is composed of a rod-shaped member bent in a convex shape on the upper side, with both ends in the lengthwise direction fixed to the leg part 21. As shown in FIG. 5, the connecting part 23, located at the upper end of the supporting part 22, includes a first clamp part 231 that clamps the upper end of the supporting part 22, and a second clamp part 232 that clamps a rotation shaft 40 of the drum support device 4, which will be described later. With the rotation shaft 40 clamped by the second clamp part 232, the rotation shaft 40 hardly rotates about an axis A2 of the rotation shaft 40 relative to the connecting part 23 (stand 3).

As shown in FIG. 2, the drum support devices 4 are located on both sides of the drum 2 in the radial direction RD of the drum 2 mentioned above. Each drum support device 4 includes a spring 30 (elastic body), a rotation shaft 40, a rotation-shaft-side fixing part 50, and a body-part-side fixing part 60 (attachment-part-side fixing part).

The spring 30 is elastically deformable and connects the body part 11 and the stand 3 together. The spring 30 is arranged on an outer circumferential surface 11a of the body part 11, and elastically deforms only in the circumferential direction CD (orthogonal direction) of the drum 2.

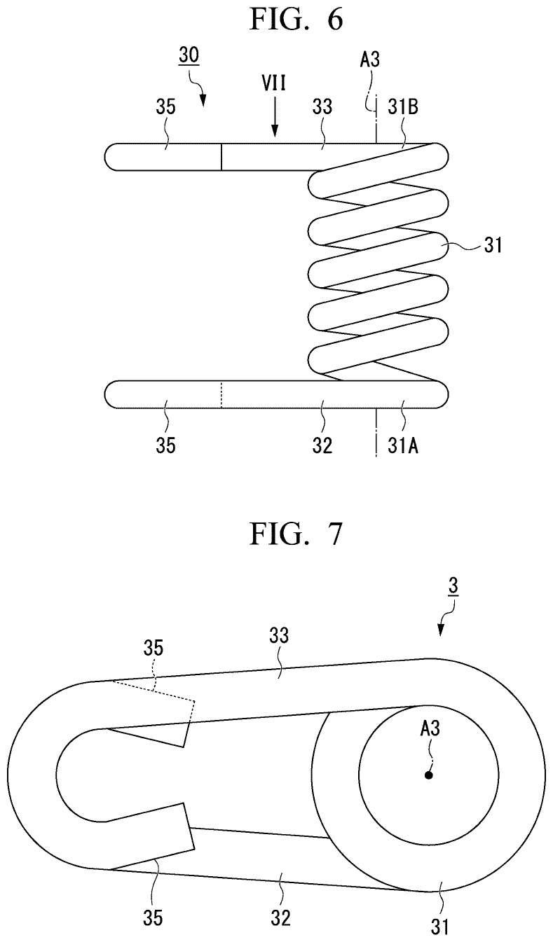

As shown in FIG. 6 and FIG. 7, the spring 30 of the present embodiment is composed of a wire material made of steel or metal, and has a spring main body 31 and two extension parts 32, 33. The spring main body 31 is formed in a helical cylindrical shape. The two extension parts 32, 33 extend radially from both axial ends of the spring main body 31. In the present embodiment, the two extension parts 32, 33 extend from the spring main body 31 in approximately the same direction. Therefore, the two extension parts 32, 33 face each other in the axial direction of the spring main body 31. Moreover, the directions in which the two extension parts 32, 33 extend are both orthogonal to an axis A3 of the spring main body 31. Thus, the two extension parts 32, 33 are parallel to each other.

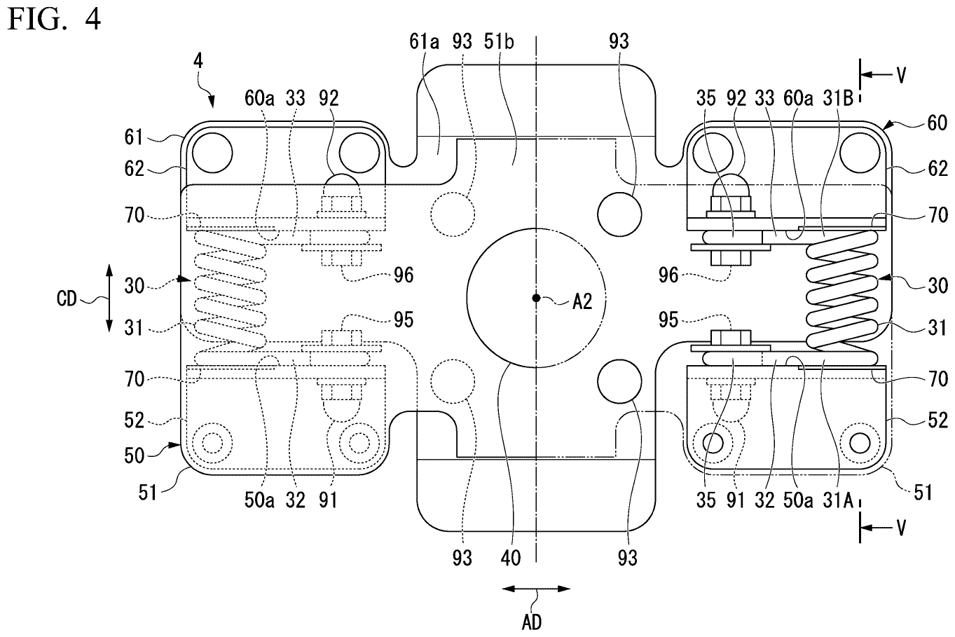

Each of the extension parts 32, 33 has an insertion part 35 for passing fixing screws 91, 92 therethrough (see FIG. 4). The insertion part 35 is located at the distal end part of each of the extension parts 32, 33 in the extending direction. The insertion part 35 in the illustrated example is formed by bending a wire material into an approximately arcuate shape.

In the spring 30 mentioned above, the two extension parts 32, 33 may extend in different directions from the spring main body 31, for example.

In the following description, one of the two ends of the spring main body 31 in the axial direction may be referred to as a first end 31A, and the other may be referred to as a second end 31B. Moreover, the extension part 32 extending from the first end 31A of the spring main body 31 may be referred to as the first extension part 32, and the extension part 33 extending from the second end 31B of the spring main body 31 may be referred to as the second extension part 33.

As shown in FIG. 2, the rotation shafts 40 rotatably support the drum 2 relative to the stand 3. The rotation shafts 40 are located on both sides of the drum 2 in the radial direction RD of the drum 2. The axes A2 of the two rotation shafts 40 both extend in the radial direction RD of the drum 2. The axes A2 of the two rotation shafts 40 coincide with each other. Also, the axes A2 of each rotation shaft 40 intersects with the axis Al of the body part 11. Moreover, the axis A2 of each rotation shaft 40 is located at the middle position of the body part 11 in the axial direction AD of the drum 2.

The axis A2 of each rotation shaft 40 may be slightly inclined relative to the radial direction RD of the drum 2, for example. Moreover, the axes A2 of the two rotation shafts 40 may be slightly offset from each other, for example. Furthermore, the axis A2 of the rotation shaft 40 does not have to intersect with the axis A1 of the body part 11, for example. However, it is more preferable that the axis A2 of the rotation shaft 40 be located near the axis A1 of the body part 11. Moreover, the axis A2 of the rotation shafts 40 may be positioned, for example, offset from the middle position of the body part 11 in the axial direction AD of the drum 2. However, it is more preferable that the axis A2 of the rotation shaft 40 be located near the middle position of the body part 11.

As shown in FIG. 2 and FIG. 5, each rotation shaft 40 of the present embodiment is located between the connecting part 23 of the stand 3 and the spring 30. Therefore, each rotation shaft 40 is fixed at a desired rotational position relative to the connecting part 23 of the stand 3. Moreover, each rotation shaft 40 is connected to the body part 11 by the spring 30.

As shown in FIG. 3 and FIG. 4, the springs 30 are located on both sides of the rotation shaft 40 when viewed in the axial direction of the rotation shaft 40. Specifically, the springs 30 are located on both sides of the rotation shaft 40 in the axial direction AD of the drum 2. It is preferable that the number of springs 30 located on both sides of the rotation shaft 40 be equal to each other. In the illustrated example, one spring 30 is located on each side of the rotation shaft 40. Moreover, the characteristics and shape of the springs 30 and the distance between the rotation shaft 40 and the springs 30 may be different between the springs 30 located on both sides of the rotation shaft 40; however, it is more preferable for them to be the same.

As shown in FIG. 4 and FIG. 5, the rotation-shaft-side fixing part 50 is fixed to the rotation shaft 40.

The rotation-shaft-side fixing part 50 has a first contact surface 50a that faces a body-part-side fixing part 60 in the circumferential direction CD of the drum 2. The first end 31A of the spring main body 31 and the first extension part 32 come into contact with the first contact surface 50a. The distal end part of the first extension part 32 is fixed to the first contact surface 50a by screw-fastening. Specifically, by passing the screw 91 through the insertion part 35 of the first extension part 32 and the portion of the rotation-shaft-side fixing part 50 that forms the first contact surface 50a, and then threading it into a nut 95, the distal end part of the first extension part 32 is fixed to the first contact surface 50a. It should be noted that, for example, the screw 91 may be passed through the insertion part 35 of the first extension part 32 and then screwed into the portion of the rotation-shaft-side fixing part 50 that constitutes the first contact surface 50a.

The body-part-side fixing part 60 is fixed to the body part 11 (attachment part) and is positioned at a distance from the rotation-shaft-side fixing part 50 in the circumferential direction CD (orthogonal direction) of the drum 2.

The body-part-side fixing part 60 has a second contact surface 60a that faces the first contact surface 50a of the rotation-shaft-side fixing part 50 in the circumferential direction CD of the drum 2. The second end 31B of the spring main body 31 and the second extension part 33 come into contact with the second contact surface 60a. The distal end part of the second extension part 33 is fixed to the second contact surface 60a by screw-fastening. Specifically, by passing the screw 92 through the insertion part 35 of the second extension part 33 and the portion of the body-part-side fixing part 60 that forms the second contact surface 60a, and then threading it into a nut 96, the distal end part of the second extension part 33 is fixed to the second contact surface 60a. It should be noted that, for example, the screw 92 may be passed through the insertion part 35 of the second extension part 33 and then screwed into the portion of the body-part-side fixing part 60 that constitutes the second contact surface 60a.

A region of the first contact surface 50a with which the first end 31A of the spring main body 31 comes into contact, and a region of the second contact surface 60a with which the second end 31B of the spring main body 31 comes into contact are each formed of a sheet-shaped cushioning material 70. The cushioning material 70 may be any material that absorbs the impact caused by a collision, and may be, for example, a urethane sheet.

The specific configurations of the rotation-shaft-side fixing part 50 and the body-part-side fixing part 60 will be further described below.

The rotation-shaft-side fixing part 50 has a first base plate 51 and a first spring-fixing member 52.

The first base plate 51 is formed in an approximately flat plate shape. The first base plate 51 is positioned such that its plate thickness direction is oriented in the radial direction RD of the drum 2. Therefore, a first surface 51a of the first base plate 51 facing in the plate thickness direction faces an outer circumferential surface 11a of the body part 11. The rotation shaft 40 is fixed to a second surface 51b of the first base plate 51 facing the opposite side to the first surface 51a. The axis A2 of the rotation shaft 40 extends from the first base plate 51 in the thickness direction thereof. In FIG. 4, a portion of the first base plate 51 located to the right of the axis A2 of the rotation shaft 40 is shown by an imaginary line.

The first spring-fixing member 52 is fixed to the first surface 51a of the first base plate 51 by screw-fastening. The first spring-fixing member 52 has the first contact surface 50a of the rotation-shaft-side fixing part 50. The first spring-fixing member 52 in the illustrated example is configured by bending a flat plate into an L-shape; however, the present disclosure is not limited to this example, and may be formed into any shape, for example, a block shape.

The body-part-side fixing part 60 has a second base plate 61 and a second spring-fixing member 62.

The second base plate 61 is formed in an approximately flat plate shape. The second base plate 61 is positioned such that its plate thickness direction is oriented in the radial direction RD of the drum 2. A first surface 61a of the second base plate 61 facing in the plate thickness direction faces the first surface 51a of the first base plate 51. The outer circumferential surface 11a of the body part 11 faces a second surface 61b of the second base plate 61 facing the opposite side to the first surface 61a. The second base plate 61 is fixed to the outer circumferential surface 11a of the body part 11 by a screw 93.

The second spring-fixing member 62 is fixed to the first surface 61a of the second base plate 61 by screw-fastening. The second spring-fixing member 62 has a second contact surface 60a of the body-part-side fixing part 60. Therefore, the second spring-fixing member 62 is positioned at a distance from the first spring-fixing member 52 in the circumferential direction CD (orthogonal direction) of the drum 2. The second spring-fixing member 62 in the illustrated example is configured by bending a flat plate into an L-shape; however, the present disclosure is not limited to this example, and may be formed into any shape, for example, a block shape.

As shown in FIG. 4, the first and second base plates 51, 61 of the present embodiment extend on both sides of the rotation shaft 40 in the axial direction AD of the drum 2 when viewed in the axial direction of the rotation shaft 40. The first and second spring-fixing members 52, 62 are located on both sides of the rotation shaft 40 in the axial direction AD of the drum 2, respectively. This allows the springs 30 to be arranged on both sides of the rotation shaft 40 in the axial direction AD of the drum 2.

In the illustrated example, the two extension parts 32, 33 of each spring 30 arranged on both sides of the rotation shaft 40 both extend in a direction approaching the rotation shaft 40 relative to the spring main body 31. It should be noted that the direction in which the two extension parts 32, 33 of each spring 30 extend from the spring main body 31 may be, for example, a direction away from the rotation shaft 40, or a direction intersecting with the direction in which the rotation shaft 40 and the spring 30 are aligned.

In the illustrated example, the directions in which the first contact surface 50a (first spring-fixing member 52) and the second contact surface 60a (second spring-fixing member 62) are aligned are the same on both sides of the rotation shaft 40. The directions in which the first contact surface 50a (first spring-fixing member 52) and the second contact surface 60a (second spring-fixing member 62) are aligned may be opposite on both sides of the rotation shaft 40, for example.

In the illustrated example, from the radially outside of the drum 2, the first base plate 51 covers the spring 30, the first and second spring-fixing members 52, 62, and the screws 93 that fix the second base plate 61 to the body part 11. The first base plate 51 covers the spring 30, thereby protecting the spring 30 and preventing a user of the drum device 1 from accidentally touching the spring 30. Moreover, since the first base plate 51 covers the screws 93 that fix the second base plate 61 to the body part 11, the second base plate 61 can be prevented from being accidentally removed from the body part 11.

As described above, in the drum support device 4 of the present embodiment and the drum device 1 including the same, the body part 11 of the drum 2 and the stand 3 are connected by the springs 30. Since the material of the springs 30 is steel or metal, it exhibits higher rigidity compared to rubber. Therefore, compared to the case where the stand 3 and the body part 11 are connected by rubber, the vibrations of the drum 2 generated when striking the drum 2 are not fully absorbed by the springs 30 and are transmitted to the stand 3 through the springs 30. In other words, it is possible to suppress the absorption of vibrations of the drum 2 by the springs 30. This allows the vibrations of the drum 2 caused by a strike to be efficiently transmitted to the stand 3 and the floor in turn. It is thus possible to improve sound resonance during drum performance.

Additionally, the springs 30 that connect the stand 3 and the body part 11 exhibit smaller variations in characteristics, such as elasticity, compared to rubber. As a result, the manner of the oscillation of the drum 2 relative to the stand 3 when striking the drum 2 becomes stable. As a result, it becomes possible to stably manufacture the drum support device 4 that satisfies the desired conditions (that is, the conditions for the manner of the oscillation of the drum 2 relative to the stand 3 when striking the drum 2).

Furthermore, the spring 30 allows for easy adjustment of the susceptibility of the drum 2 to oscillation simply by changing its spring constant. Therefore, the balance between the playability of the drum 2 and the sound resonance (sound sustain) of the sound of the drum 2 can be easily adjusted. To describe this point, if the drum 2 is prone to oscillation, the sound resonance (sound sustain) of the drum 2 improves, but the playability of the drum 2 deteriorates. Conversely, if the drum 2 is resistant to oscillation, the playability of the drum 2 improves, but the sound resonance (sound sustain) of the drum 2 diminishes. Therefore, by adjusting the spring constant of the springs 30 to appropriately adjust the ease of oscillation of the drum 2, it is possible to adjust the balance between the playability of the drum 2 and the sound resonance (sound sustain) of the sound of the drum 2.

Also, in the drum support device 4 of the present embodiment and the drum device 1 including the same, the elastic body (spring 30) connecting the body part 11 of the drum 2 and the stand 3 elastically deforms only in the orthogonal direction that is orthogonal to the radial direction RD of the drum 2. Therefore, when the drum 2 is struck, the elastic body does not stretch or contract in the radial direction RD of the drum 2. This suppresses the vibrations of the drum 2 caused by the strike from being absorbed by the elastic body, and allows the vibrations of the drum 2 caused by the strike to be efficiently transmitted to the stand 3 and the floor in turn. It is thus possible to improve sound resonance during drum performance.

Moreover, since the elastic body (springs 30) connecting the body part 11 and the stand 3 elastically deform only in the direction orthogonal to the radial direction RD of the drum 2, the direction in which the drum 2 oscillates relative to the stand 3 when the drum 2 is struck is limited. This allows the player to strike the drum 2 more easily, which means that an improvement in the playability of the drum 2 can be achieved.

In the drum support device 4 of the present embodiment, the springs 30 that elastically deform only in the orthogonal direction orthogonal to the radial direction RD of the drum 2 are located on both sides of the rotating shaft 40 when viewed from the axial direction of the rotating shaft 40. Therefore, when the drum 2 is struck, the springs 30 located on both sides of the rotating shaft 40 are elastically deformed, so that the drum 2 can easily oscillate about the rotating shaft 40 relative to the stand 3. This makes it possible to ensure both the playability of the drum 2 and the sound resonance (sound sustain) of the drum 2.

Moreover, it is possible to easily adjust the ease with which the drum 2 oscillates by adjusting the position of each spring 30 relative to the rotation shaft 40 (the distance between the rotation shaft 40 and each spring 30). This allows for the appropriate adjustment of the susceptibility of the drum 2 to oscillation, making it possible to adjust the balance between the playability of the drum 2 and the sound resonance (sound sustain) of the drum 2.

Furthermore, in the drum support device 4 of the present embodiment, the spring 30 includes two extension parts 32, 33 that extend in the radial direction RD of the spring main body 31 at both ends in its axial direction. Then, the distal end parts of the two extension parts 32, 33 are fixed by screw-fastening to the rotation-shaft-side fixing part 50 and the body-part-side fixing part 60 (attachment-part-side fixing part). This allows both ends of the spring 30 in the axial direction to be easily fixed to the rotation-shaft-side fixing part 50 and the body-part-side fixing part 60 independently.

It should be noted that it is difficult to independently fix both ends of the spring main body 31, which is formed in a helical cylindrical shape, to the rotation-shaft-side fixing part 50 and the body-part-side fixing part 60 by screw-fastening. This difficulty arises from the fact that it is challenging to pass the screws 91, 92, which are used to fix one end of the spring main body 31 to either the rotation-shaft-side fixing part 50 or the body-part-side fixing part 60, through the interior of the spring main body 31. Furthermore, it is also challenging to manipulate the screws 91, 92 that have been passed through the interior of the spring main body 31 within the spring main body 31 to thread them into the rotation-shaft-side fixing part 50 or the body-part-side fixing part 60.

Furthermore, in the drum support device 4 of the present embodiment, the spring 30 is arranged between the rotation-shaft-side fixing part 50 and the body-part-side fixing part 60 which are aligned in the circumferential direction CD (orthogonal direction) of the drum 2, thereby enabling the spring 30 to reliably elastically stretch and contract in the circumferential direction CD of the drum 2.

Moreover, in the drum support device 4 of the present embodiment, the two extension parts 32, 33 of the spring 30 face each other in the axial direction of the spring main body 31 and extend orthogonally to the axial direction of the spring main body 31. Then, the first end 31A of the spring main body 31 and the first extension part 32 contact the first contact surface 50a of the rotation-shaft-side fixing part 50, while the second end 31B of the spring main body 31 and the second extension part 33 contact the second contact surface 60a of the body-part-side fixing part 60.

As a result, even if the rotation-shaft-side fixing part 50 and the body-part-side fixing part 60 move relative to each other in response to the drum 2 being struck, the axial direction of the spring main body 31 can be maintained in a state of being substantially orthogonal to the first contact surface 50a of the rotation-shaft-side fixing part 50 and the second contact surface 60a of the body-part-side fixing part 60. This makes it possible to suppress the spring main body 31 from significantly deflecting and bending. This effectively suppresses or prevents the instability in the way the drum 2 oscillates relative to the stand 3 when the drum 2 is struck, which would otherwise occur due to significant deflection and deformation of the spring main body 31. Consequently, it is possible to suppress or prevent a reduction in the playability of the drum 2.

Furthermore, in the drum support device 4 of the present embodiment, the regions of the first contact surface 50a and the second contact surface 60a with which the first end 31A and the second end 31B of the spring main body 31 come into contact are formed by the sheet-shaped cushioning material 70. Therefore, even if the first end 31A and the second end 31B of the spring main body 31 collide with the rotation-shaft-side fixing part 50 and the body-part-side fixing part 60, respectively, due to the rotation-shaft-side fixing part 50 and the body-part-side fixing part 60 moving relatively in the orthogonal direction in response to the drum 2 being struck, the impact of such collisions can be absorbed by the cushioning material 70. This makes it possible to suppress or prevent the generation of collision noise resulting from the collisions mentioned above. In the drum device 1, unintended sounds other than the desired one (for example, the sound produced when striking the striking surface 2a) are undesirable for a musical instrument. Therefore, suppressing or preventing the occurrence of the collision noise mentioned above is highly beneficial.

Furthermore, in the drum support device 4 of the present embodiment, the spring 30 (elastic body) that connects the body part 11 and the stand 3 elastically deforms only in the circumferential direction CD of the drum 2 (the direction orthogonal to the radial direction RD and the axial direction AD of the drum 2). As a result, when the spring 30 elastically deforms upon striking the striking surface 2a of the drum 2, which faces in the axial direction AD, it is possible to effectively suppress the displacement of the striking surface 2a of the drum 2 relative to the stand 3 in the axial direction AD. This allows the player to strike the striking surface 2a of the drum 2 more easily, which means that an improvement in the playability of the drum 2 can be achieved.

The present disclosure has been described in detail above; however, the present disclosure is not limited to the above embodiment, and various modifications may be made without departing from the scope of the present disclosure.

In the present disclosure, the springs 30, which are positioned on both sides of the rotation shaft 40 when viewed along the axial direction of the rotation shaft 40, need only to elastically deform in at least the direction orthogonal to the rotation shaft 40. Therefore, the springs 30 positioned on both sides of the rotation shaft 40 are not limited to being located on opposite sides of the rotation shaft 40 along the axial direction AD of the drum 2, but may, for example, be located on opposite sides of the rotation shaft 40 along the circumferential direction CD of the drum 2.

In the present disclosure, it is sufficient that the rotation shaft 40 and the spring 30 are connected at least between the drum 2 and the stand 3. Therefore, the rotation shaft 40 may be located between the body part 11 and the spring 30, for example. In such a case, the rotating shaft 40 is fixed to the body part 11. Moreover, each rotation shaft 40 is connected to the stand 3 by the spring 30. In such a configuration, for example, the distal end part of the first extension part 32 of the spring 30 may be fixed to the rotation-shaft-side fixing part 50, which is fixed to the rotating shaft 40, by screw-fastening. Moreover, the distal end part of the second extension part 33 of the spring 30 may be fixed by screw-fastening to a stand-side fixing part (attachment-part-side fixing part) that is fixed to the stand 3 (attachment part). The stand-side fixing part may be formed integrally with the connecting part 23 of the stand 3, for example.

Based on the foregoing, the drum support device of the present disclosure may include, for example: a rotation-shaft-side fixing part 50 fixed to the rotation shaft 40; and an attachment-part-side fixing part (body-part-side fixing part 60, stand-side fixing part) fixed to the attachment part of either the body part 11 or the stand 3 and positioned with a space in the orthogonal direction relative to the rotation-shaft-side fixing part 50.

The drum support device 4 of the present disclosure may not include, for example, the rotation shaft 40. In such a case, the body part 11 and the stand 3 may be directly connected by the springs 30.

In the present disclosure, the spring 30 that connects the body part 11 and the stand 3 is not limited to elastic deformation in the circumferential direction CD of the drum 2, but may elastically deform in any direction (for example, in the radial direction RD and axial direction AD of the drum 2).

In the present disclosure, the connection between the body part 11 and the stand 3 is not limited to being made by the spring 30, but may be made by at least an elastic body that is elastically deformable. The elastic body may be, for example, rubber.

In the present disclosure, if the elastic body connecting the body part 11 and the stand 3 is not a spring, the elastic body need only elastically deform in at least the orthogonal direction that is orthogonal to the radial direction RD of the drum 2. Therefore, the direction in which the elastic body, which is different from a spring, elastically deforms may be, for example, the axial direction AD of the drum 2, or a direction inclined relative to both the axial direction AD and the circumferential direction CD of the drum 2.

In the present disclosure, the drum is not limited to a concert bass drum and need only include a body part with at least one opening and a head covering the opening of the body part. The drum may be, for example, a snare drum, a timpani, a bongo, a conga, or the like.

According to the present disclosure, it is possible to improve sound resonance during drum performance.

What is claimed is:

1. A drum support device for supporting a body part of a drum with respect to a drum stand, comprising:
a spring having, in an axial direction of the spring, a first end and a second end,
wherein the body part of the drum is connected to the first end of the spring, and the drum stand is connected to the second end of the spring.

2. The drum support device according to claim 1, further comprising:
a rotation shaft configured to rotatably support the drum with respect to the drum stand,
wherein the rotation shaft and the spring are connected to each other between the drum and the drum stand.

3. The drum support device according to claim 2,
wherein the spring is configured to elastically deform only in an orthogonal direction, the orthogonal direction being a direction orthogonal to a radial direction of the drum, and
wherein the drum support device comprises two springs positioned on both sides of the rotation shaft, as viewed in an axial direction of the rotation shaft, respectively.

4. The drum support device according to claim 2, further comprising:
a rotation-shaft-side fixing part that is fixed to the rotation shaft; and
an attachment-part-side fixing part that is fixed to an attachment part of either the body part or the drum stand and that is positioned at a distance from the rotation-shaft-side fixing part in an orthogonal direction, the orthogonal direction being a direction orthogonal to a radial direction of the drum,
wherein the spring is configured to elastically deform only in the orthogonal direction,
wherein the spring comprises:
a spring main body having a helical tube shape, the spring main body having the first end and the second end in the axial direction of the spring main body;
a first extension part extending in a radial direction of the spring main body and from the first end of the spring main body; and
a second extension part extending in the radial direction of the spring main body and from the second end of the spring main body,
wherein a distal end part of the first extension part is fixed to the rotation-shaft-side fixing part by screw-fastening, and
wherein a distal end part of the second extension part is fixed to the attachment-part-side fixing part by screw-fastening.

5. The drum support device according to claim 4,
wherein the first extension part and the second extension part face each other in the axial direction of the spring main body,
wherein the rotation-shaft-side fixing part has a first contact surface that faces the attachment-part-side fixing part, the first contact surface being in contact with the first end of the spring main body and the first extension part, and
wherein the attachment-part-side fixing part has a second contact surface that faces the rotation-shaft-side fixing part, the second contact surface being in contact with the second end of the spring main body and the second extension part.

6. The drum support device according to claim 5, wherein a first region of the first contact surface where the first end of the spring main body is in contact with the first contact surface and a second region of the second contact surface where the second end of the spring main body is in contact with the second contact surface each include a sheet-shaped cushioning material.

7. A drum device comprising:
the drum support device according to claim 1;
the drum; and
the drum stand that supports the body part of the drum,
wherein the drum support device comprises two drum support devices provided on both sides of the drum in a radial direction of the drum, respectively.

8. A drum support device for supporting a body part of a drum with respect to a drum stand, comprising:
an elastic body having, in an axial direction of the elastic body, a first end and a second end,
wherein the body part of the drum is connected to the first end of the elastic body, and the drum stand is connected to the second end of the elastic body, and
wherein the elastic body is configured to elastically deform only in an orthogonal direction, the orthogonal direction being a direction orthogonal to a radial direction of the drum.

9. The drum support device according to claim 8, wherein the elastic body comprises a spring.

10. The drum support device according to claim 9, further comprising:
a rotation shaft configured to rotatably support the drum with respect to the drum stand,
wherein the rotation shaft and the spring are connected to each other between the drum and the drum stand.

11. The drum support device according to claim 8,
wherein the drum has a surface to be struck that faces in an axial direction of the drum, the axial direction of the drum being orthogonal to the radial direction of the drum, and
wherein the orthogonal direction in which the elastic body elastically deforms is a direction orthogonal to both the radial direction of the drum and the axial direction of the drum.

12. A drum device comprising:
the drum support device according to claim 8;
the drum; and
the drum stand that supports the body part of the drum,
wherein the drum support device comprises two drum support devices provided on both sides of the drum in the radial direction of the drum, respectively.
